(19) United States
(12) Patent Application Publication
(10) Pub. No.: US 2008/0170188 A1
(43) Pub. Date: Jul. 17, 2008

(54) LIQUID CRYSTAL DISPLAY PANEL AND ELECTRONIC APPARATUS UTILIZING THE SAME

(75) Inventors: Shih-Chyuan Fan Jiang, Hsinchu (TW); Ching-Huan Lin, Hsinchu (TW); Chih-Ming Chang, Hsinchu (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: AU OPTRONICS CORP., Hsinchu (TW)

(21) Appl. No.: 11/837,571

(22) Filed: Aug. 13, 2007

(30) Foreign Application Priority Data
Jan. 15, 2007 (TW) 96101460

(51) Int. Cl. G02F 1/13357; G02F 1/1335

(52) U.S. Cl. 349/109; 349/106; 349/114

(57) ABSTRACT

Disclosed is a liquid crystal display panel having one or more light holes in the reflection region for improving the aperture ratio and color uniformity at different view angles. The light holes are formed at the reflection region having an alignment protrusion as a center. The light holes are substantially arranged around the alignment protrusion with substantially identical total area, or at least one light hole formed at the reflection region having the alignment protrusion in the light hole as a center.

### BACKGROUND OF THE INVENTION

1. Field of the Invention

The present invention relates to liquid crystal display (LCD) and, more particular, to the formation of light holes of color filters in reflection regions of a LCD.

2. Description of the Related Art

Liquid crystal display (hereinafter LCD) is widely applied in flat plane displays. Compared to cathode ray tube (CRT), plasma display panel (PDP), or organic light-emitting display (OLED), LCD comprises disadvantages such as narrower view angle and slower response time. While such problems have gradually been solved by modification, mature LCD manufactures predominate other immature displays in cost.

For example, in-plane switching (IPS) or multi-domain vertical alignment (MVA) is applied to improve narrow view angle, with the latter only requiring an additional patterned photoresist layer to form alignment protrusions, making MVA widely applicable in large scale LCD panels with wide view angle.

Furthermore, the backlight module's cost occupied a major ratio of the LCD's panel. Conventional transmissive LCDs can be replaced by reflective LCDs for cost and power consumption considerations. The light source of the reflective LCD is environmental. Incident environmental light is reflected by reflective electrodes in the panel and integrated into the display, and then into the human's eye. If the environment is sufficiently bright, the panel may clearly display without backlight module. When environmental light is strong, as in sunlight, the reflective LCD may display clearer image than the transmissive LCD.

Even with the advantages described, however, the reflective LCD has shortcomings. If the environment is not sufficiently bright or totally dark, the reflective LCD cannot display images. Thus transflective LCDs has been developed, combining reflective LCD and transmissive LCD technologies. Parts of the transflective LCD are reflective regions, and other parts of the transflective LCD are transmission regions. Thus transflective LCDs can display using backlight in transmission regions in dark environments, and the white screen prevented by reflection regions under strong environmental light.

FIG. 1A is a diagram showing a conventional transflective MVA-LCD. In FIG. 1A, gate lines 11A and data lines 11B perpendicularly cross each other to define a plurality of pixels 100 including three sub-pixels 13R, 13G, and 13B driven by thin film transistors 11T (hereinafter TFT), respectively. The sub-pixels 13R, 13G, and 13B are divided into reflection regions 17A and transmission regions 17B. The regions 17A and 17B are separated by groove 16 and connected by connection electrode 15C. Reflection electrodes 15A are formed in the reflection regions 17A, and the transmission electrode 15B are formed in transmission regions 17B, respectively. For multi-vertical domain of the liquid crystal molecules, alignment protrusions 19 are formed in the center of the reflection and transmission regions 17A and 17B.

FIG. 1B is a cross-section view of line A-A in FIG. 1A. Liquid crystal layer 12B is disposed between the color filter substrate 12A and array substrate 12C. As shown in FIG. 1B, the color filter substrate 12A sequentially comprises substrate 101A, color filter 103R, transparent electrode layer 15D, and alignment protrusion 19. As described, alignment protrusions 19 are formed for multi-vertical domain of the liquid crystal molecules 10 of the liquid crystal layer 12B. The array substrate 12C sequentially comprises substrate 101B, gate line 11A coated by dielectric layer 14A, data line (not shown) coated by dielectric layer 14B, and reflection electrode layer 15A, transparent electrode 15B, and connection electrode 15C connecting both. The reflection electrode 15A of the reflection region 17A and the transmission electrode 15B of the transmission region 17B are connected by connection electrode 15C. In reflection region 17A, the environmental light 18A acts as incident light from outside of the color filter substrate 12A, passing through liquid crystal layer 12B, reflected by the reflection electrode 15A of the array substrate 12C, and then passing through the liquid crystal layer 12B and the color filter substrate 12A to reach users' eye. In transmission region 17B, light 18B from light source (not shown) passes through transparent electrode 15B of the array substrate 12C and color filter substrate 12A to reach user's eye. It is obvious that the light 18A in the reflection region 17A passes through the color filter 103A twice (e.g. incident and reflection), and the light 18B in the transmission regions 17B passes through the color filter 103A once, such that the light color from the reflection and transmission regions 17A and 17B will differ in density or other properties. For achieving normalized color density in reflection and transmission regions 17A and 17B, conventional modification adopts higher pigment concentration in color filter 103R of the transmission region 17A and lower pigment concentration in color filter 103R of the reflection region 17B. This modification requires an extra lithography process to form color filters of different pigment concentrations. In the case of a conventional RGB color filter substrate, the modification requires three additional lithography processes, thereby greatly enhancing the cost of color filter substrate.

### SUMMARY OF THE INVENTION

The present invention provides a liquid crystal display panel, comprising two oppositely disposed substrates, each comprising a plurality of corresponding regions, at least one of the regions is a reflection region, and the reflection region comprises at least one alignment protrusion; a liquid crystal layer formed between the two substrates; a color filter formed on one of the two substrates, wherein the color filter in the reflection region comprises a plurality of light holes, and the light holes are substantially symmetrical distributed according to the alignment protrusion as a center.

The present invention also provides an electronic apparatus, comprising the disclosed liquid crystal display panel.

The present invention further provides a liquid crystal display panel, comprising two oppositely disposed substrates, each comprising a plurality of corresponding regions, at least one of the regions is a reflection region, and the reflection region comprises at least one alignment protrusion; a liquid crystal layer formed between the two substrates; a color filter formed on one of the two substrates, wherein the color filter in the reflection region comprises at least one light hole, wherein the alignment protrusion is formed in the at least one light hole, and the at least one light hole is substantially symmetrical according to the alignment protrusion as a center and has at least three substantially identical distances.

The present invention also provides an electronic apparatus, comprising the disclosed liquid crystal display panel.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1A is a plan view of a conventional transflection liquid crystal display;

FIG. 1B is a cross-section view of line A-A in FIG. 1A;

FIG. 2 shows a layout of the active layer in an embodiment of the present invention;

FIGS. 3A-3B are diagrams of a liquid crystal display panel in embodiments of the present invention,

FIG. 4 is a plan view of alternately arranged transmission regions and reflection regions in an embodiment of the present invention;

FIGS. 5A-5H are plan views of light holes of a color filter in a reflection region in embodiments of the present invention;

FIGS. 6A-6F are plan views of light holes of a color filter in a reflection region in embodiments of the present invention;

FIGS. 7A-7G are cross-section views of liquid crystal display panels in embodiments of the present invention;

FIG. 8 is a plan view of different color filters in reflection regions having light holes with substantially different area; and

FIG. 9 is a diagram of an electronic apparatus in an embodiment of the present invention.

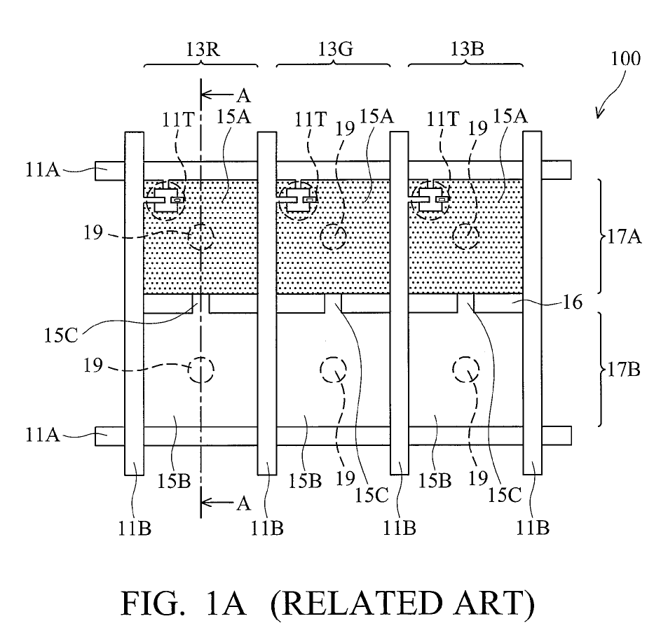

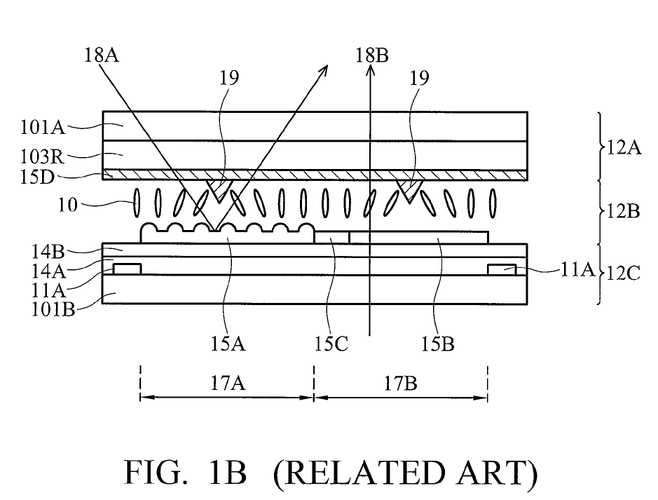

### DETAILED DESCRIPTION OF THE INVENTION

The following description is of the best-contemplated mode of carrying out the invention. This description is made for the purpose of illustrating the general principles of the present invention and should not be taken in a limiting sense. The scope of the present invention is best determined by reference to the appended claims.

For achieving normalized color density at different view angles and different regions (e.g. transmission regions and reflection regions), the present invention provides varied patterns of the light hole. Especially in reflective manipulation, the color density of different view angles is substantially normalized or substantially identical.

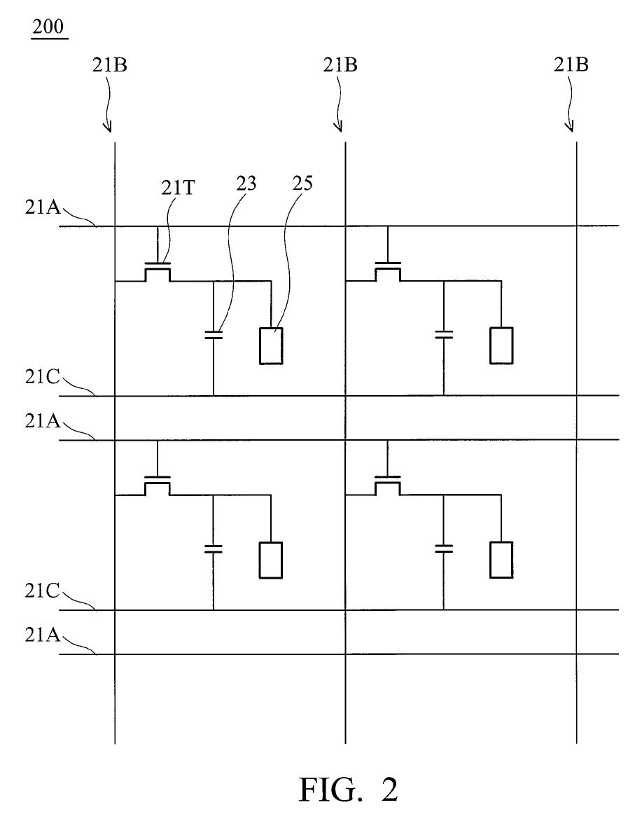

FIG. 2 shows a layout of the active layer in an embodiment of the present invention. The layout of the active layer includes gate lines 21A, data lines 21B, control devices 21T, and storage capacitance 23. The gate lines 21A and data lines 21B are substantially staggered to form a plurality of sub-pixels 200. Each sub-pixel 200 includes at least one control device 21T. The gate electrode, the source electrode, and the drain electrode of the control device 21T are extensions of one gate line 21A, connected to one data line 21B, and connected to pixel electrode 25, respectively. The layout of the active layer, preferably, further includes at least one common line 21C. The storage capacitance 23 of the sub-pixel 200 can comprise part of the gate line 21A and pixel electrode 25, part of the pixel electrode 25 and common line 21C, or combinations thereof. As well as conventional RGB, the color filter corresponding to the sub-pixels 200 further includes cyan, tallow, magenta (CYM), or other colors to display true color. The active layer can be formed as a conventional array substrate combined with liquid crystal layer and color filter substrate to complete the liquid crystal panel. Alternatively, the described active layer can be applied in array on color filter (AOC) substrate, color filter on array (COA) substrate, and the like.

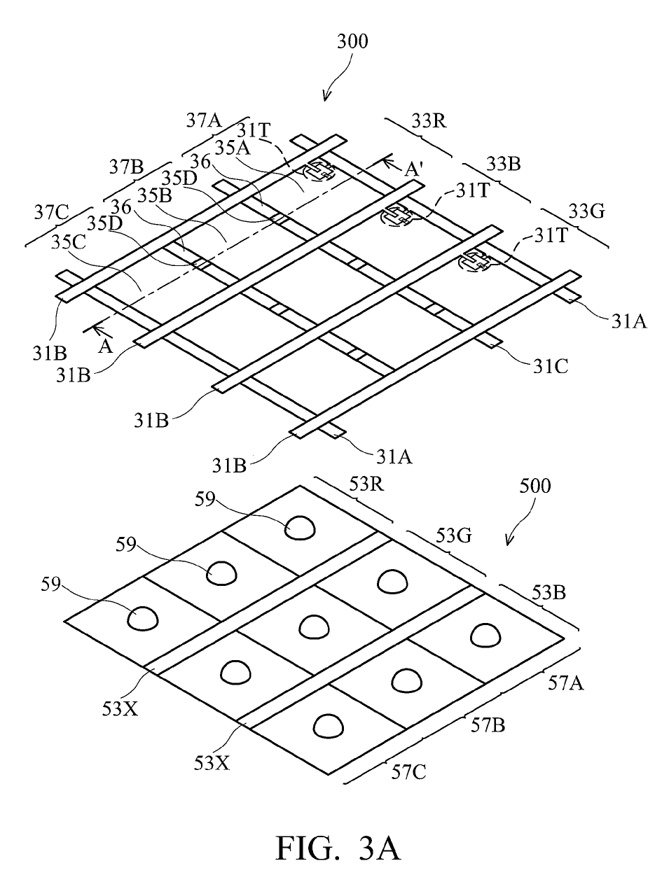

FIG. 3A is a diagram showing an LCD panel. As shown in FIG. 3A, a liquid crystal layer (not shown) is disposed between two oppositely disposed substrates 300 and 500 to constitute an LCD panel. The two substrates 300 and 500 comprise a plurality of corresponding regions. An embodiment of the present invention comprises three regions (37A, 37B, and 37C), but is not limited thereto, and can comprise two, four, five, or other number. In this embodiment, the substrate 300 serves as array substrate and the substrate 500 serves as color filter substrate. The array substrate 300 includes gate lines 31A, data lines 31B, and control devices 31T. The gate lines 31A and data lines 31B are substantially staggered to define three sub-pixels (33R, 33G, and 33B) as an exemplification of the present embodiment. The sub-pixel number is not limited to three, and can be two, four, five, or other number. Sub-pixels 33R, 33G, and 33B include at least one control device, respectively. Sub-pixels 33R, 33G, and 33B correspond to red, green, and blue color filters 53R, 53G, and 53B of the color filter substrate 500 on the opposite side. Black matrices 53X are preferably formed between the color filters to avoid light mixing. The materials of the black matrices 53X include organic material, conductive material, or combinations thereof. The organic material comprises colored photoresist, colored polymer, and the like. The conductive material comprises Cr, Au, Ag, Cu, Fe, Sn, Pb, Mo, Nd, Ti, Ta, nitrides thereof, oxides thereof, oxynitrides thereof, alloys thereof, or combinations thereof. For example, region 37A can include sub-pixel 33R, control device 31T in pixel electrode layer 35A, and one of the corresponding regions in color filter 53R. Region 37B includes sub-pixel 33R, pixel electrode layer 35B, and one of the corresponding regions in color filter 53R. Region 37C includes sub-pixel 33R, pixel electrode layer 35C, and one of the corresponding regions in color filter 53R. The control device 31T can be top-gate transistor or bottom-gate transistor, wherein the transistor includes a semiconductor layer (not shown) such as microcrystalline silicon, polysilicon, single crystal silicon, amorphous silicon, or combinations thereof. For multi-vertical domain of liquid crystal molecules, alignment protrusions 59 are formed in at least one of the regions 37A, 37B, and 37C. As shown in FIG. 3A, the aliginent protrusions 59 are forined in at least one of the regions 37A, 37B, and 37C in one embodiment of the present invention, however, the position of the alignment protrusions 59 is not limited thereto. Corresponding to the alignment protrusions 59 formed on the color filter substrate 500, slits or another alignment protrusions (not shown) may be formed at least one of the pixel electrode layers 35A, 35B, and 35C. In FIG. 3A, pixel electrodes in different regions are separated by grooves 36, and connected by connection electrodes 35D. Although pixel electrodes in two different regions are connected by only one connection electrode 35D, the number of connection electrodes is optional with function of grooves 36 not influenced. The grooves 36 help the liquid crystal molecules tilt in the direction of individual regions, such that assist in alignment of the liquid crystal molecule to form multi-domains.

The aperture ratio of the LCD display can be enhanced by overlapping the common lines 31C and grooves 36. Note that the alignment protrusions 59 are not necessarily formed on the color filter substrate 500, nor are other alignment protrusions or slits necessarily formed on the array substrate 300. The alignment protrusions 59 can optionally be formed on one of the two substrates, with other slits or alignment protrusions correspondingly formed on the opposite substrate. As shown in FIG. 3B, alignment protrusions 59 are formed on the array substrate 300 but are not limited thereto. If array substrate is integrated with color filter (e.g. AOC or COA), the alignment protrusions 59 are formed on the array substrate integrated with color filter, or on the substrate with no array or color filter. Preferred, At least one of the other alignment protrusions and slits are formed corresponding to the substrate on which alignment protrusions 59 are formed, but are not limited thereto. Accordingly, the alignment protrusions 59 and other alignment protrusions/slits can be formed on the same or different substrates. Note that if one substrate includes color filter and array (e.g. AOC or COA) and the alignment protrusions and the other alignment protrusions/slits formed on different substrates, at least one of the other alignment protrusions/slits can be formed on the substrate including color filters or the opposite substrate without array and color filters.

In an embodiment of the present invention, the LCD panel is reflective. The regions 37A, 37B, and 37C are reflection regions in this embodiment, and the pixel electrode layer 35A, 35B, and 35C are reflection electrode layers. In another embodiment of the present invention, the LCD panel is transflective. At least one of the regions 37A, 37B, and 37C is transmission region and at least one of regions 37A, 37B, and 37C is reflection region in this embodiment, and the position of the reflection regions is optional. The control devices 31T are preferably formed in reflection regions for improving aperture ratio, but are not limited thereto.

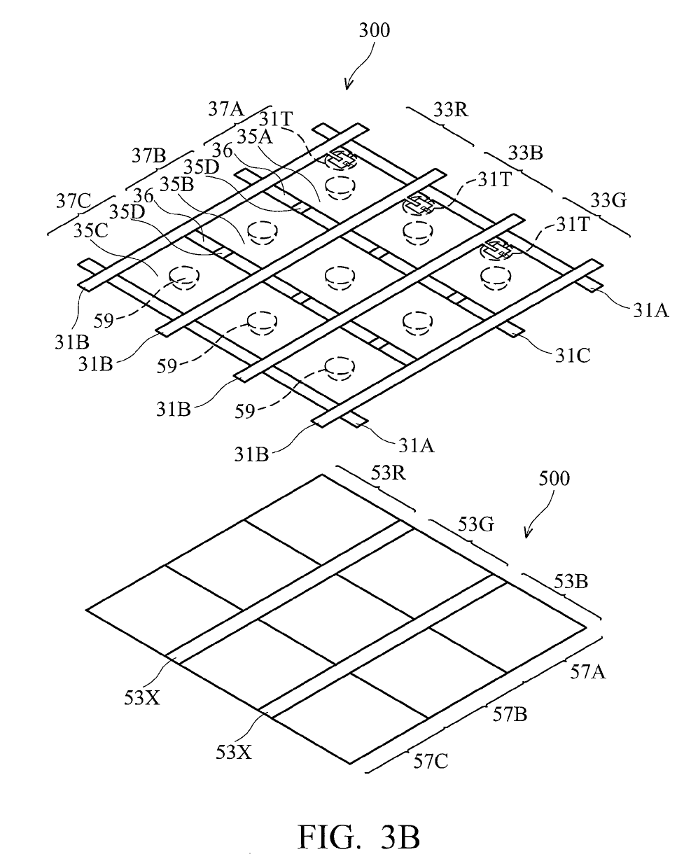

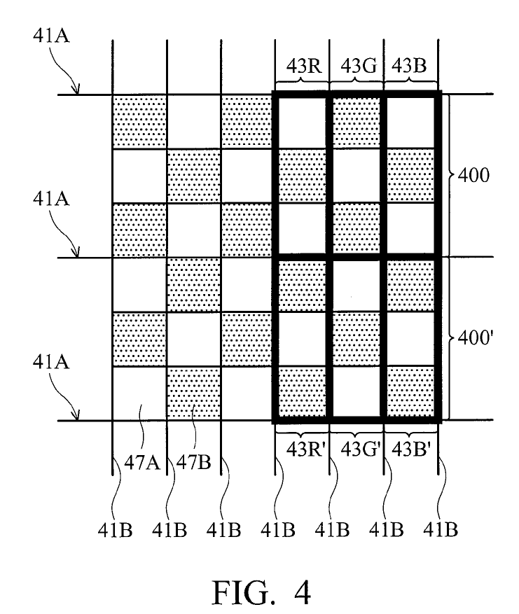

In an embodiment of the transflective LCD, the transmission and reflection regions are preferably alternately arranged as shown in FIG. 4, but are not limited thereto. In FIG. 4, gate lines 41A substantially intersect data lines 41B to form complementary pixels 400 and 400′. Each pixel 400 includes three sub-pixels 43R, 43G, and 43B, but the number of sub-pixel numbers is not limited and can be two, four, five, or other. For example of sub-pixels 43R and 43B, the transmission regions 47A (not dotted) are formed on top and bottom sides, and the reflection region 47B (dotted) is formed in the middle. For example of sub-pixel 43G, the transmission region 47A is formed in the middle, and the reflection regions 47B are formed on the top and bottom. The pixel 400′ has sub-pixels 43R′, 43G′, and 43B′, wherein the position of the transmission and reflection regions is totally opposite to the pixel 400, but is not limited thereto. By alternately arranging pixels 400 and 400′, the transmission and reflection regions are alternately arranged like as chessboard arranged.

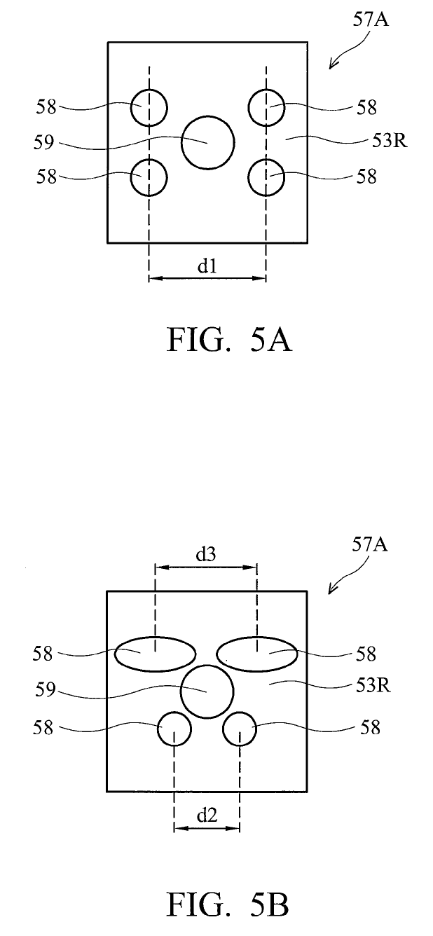

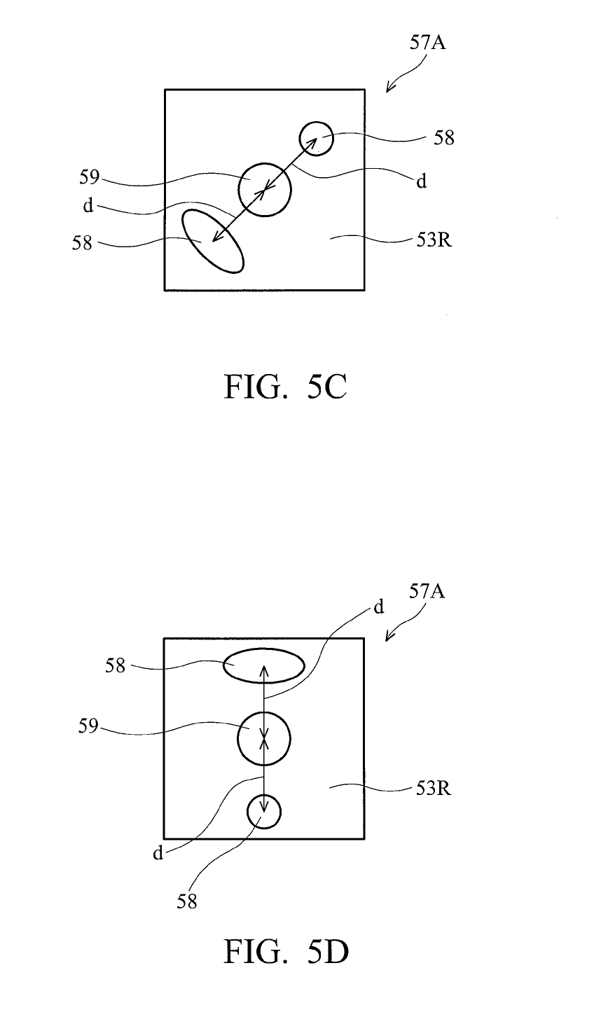

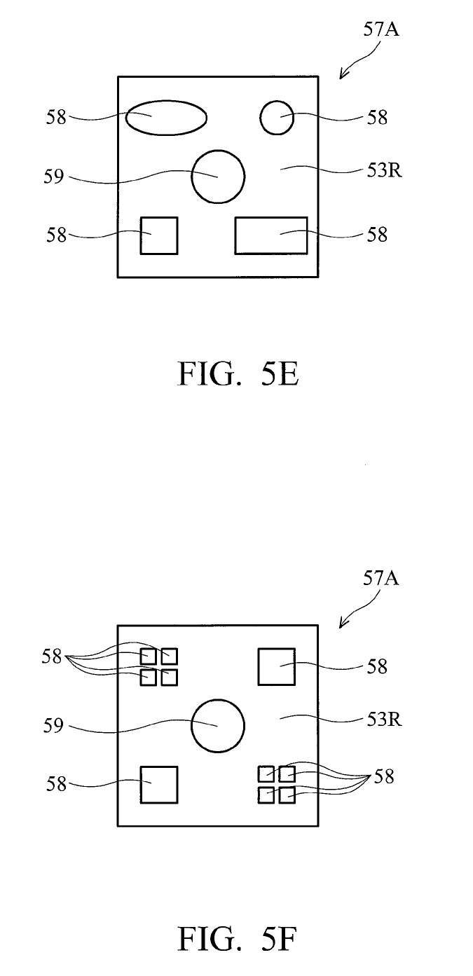

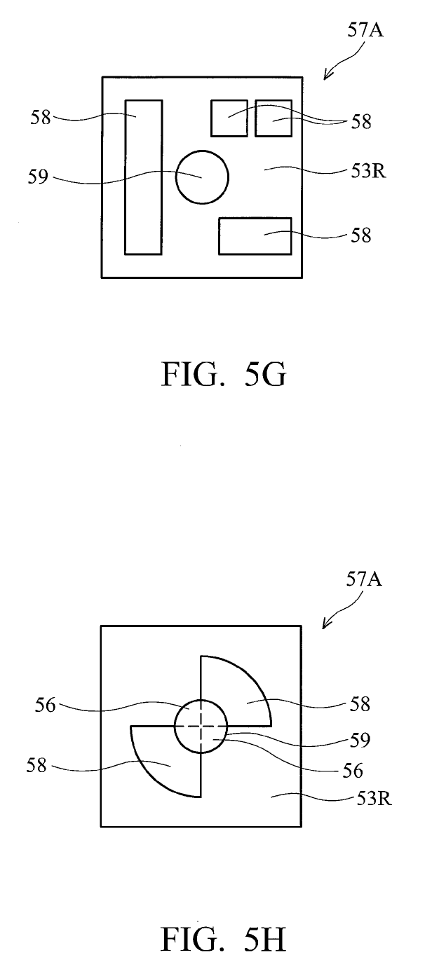

FIG. 5A is a plan view of light holes of a color filter in a reflection region in an embodiment of the present invention. For improving the aperture of the reflection region 57, color filters 53R, 53G, and 53B of the reflection region 57A are patterned to form a plurality of light holes 58. These light holes 58 are substantially symmetrical distributed according to the alignment protrusion 59 as a center, and are divided into two sides by the alignment protrusion 59 so as to allow the sum areas of the light holes in substantially different sides are substantially identical. This design normalizes color density of light from different view angles (e.g. up, down, right, left, oblique, and the like). For simplification, the following figure is illustrated by light holes 58 of the color filter 53R in the reflection region 57A. In FIG. 5A, the light holes 58 substantially symmetrical divided (e.g. up/down or right/left) by the alignment protrusion 59 have the substantially identical shape, and light holes 58 are separated by an interval of d1. The distance (such as horizontal axis) between the center of the alignment protrusion 59 and the centers of the light holes 58 is half of d1 (d1/2). In FIG. 5B, the top light holes 58 are separated by an interval of d3, and the underside light holes 58 are separated by an interval of d2, wherein the intervals d2 and d3 can be substantially identical or substantially different. The distance (such as horizontal axis) between the center of alignment protrusion 59 and the centers of the up/down light holes 58 are half of d3 (d3/2) and half of d2 (d2/2), respectively. The distances d2/2 and d3/3 (such as horizontal axis) can be substantially identical or substantially different. In FIG. 5B, the distribution of light holes 58 is substantially symmetrical to the right/left but substantially asymmetrical up/down, and the top light holes 58 and the underside light holes have substantially different shapes. In other embodiments of the present invention, the light holes 58 may be substantially symmetrical according to the alignment protrusion 59 as a center as shown in FIGS. 5C and 5D. In FIG. 5C, two light holes 58 are substantially symmetrical in obliquely directional according to the alignment protrusion 59 as a center, and the distance between the center of the alignment protrusion 59 and the centers of the two light holes 58 are d. In FIG. 5D, two light holes 58 are substantially symmetrical in vertically directional according to the alignment protrusion 59 as a center. The distance between the center of the alignment protrusion 59 and the centers of the the up/down light holes 58 are d. Although light holes 58 on two sides have substantially different shapes in FIGS. 5C and 5D, the substantially identical shape light holes can be optionally selected. In other embodiments of the present invention, the up/down/right/left light holes 58 have substantially different shapes as shown in FIG. 5E. In FIG. 5F, the amounts of up/down light holes 58 are substantially identical, and the amounts of right/left light holes 58 are substantially identical. In FIG. 5G, the amounts of up/down light holes 58 are substantially different, and the amounts of right/left holes are substantially different. In FIGS. 5A-5G, the light holes 58 and the alignment protrusion 59 do substantially not overlap. However, the alignment protrusion 59 may overlap part of light holes 58, located in the boundary between the light holes 58 and at least one non-light hole region 56 of the color filters 57A as shown in FIG. 5H. If two sides (e.g. up/down, right/left, and/or oblique) light holes divided by the alignment protrusion have the substantially identical area, amounts and/or shapes of the light holes can be altered as necessary. Note that the figures of the embodiments of the present invention are illustrated by alignment protrusion formed on the color filter substrate, but are not limited thereto. In other embodiments, the light holes formed on the color filters correspond to the alignment protrusions 59 formed on the array substrate. In further embodiments, the light holes formed on a substrate include array and color filters corresponding to the alignment protrusions 59 formed on another substrate without array and color filters. In other embodiments, the light holes can correspond to the alignment protrusions 59 both formed on a substrate including array and color filters, and oppositely disposed substrate includes no array and color filters.

The shaped of the light holes can be substantially circular, substantially elliptical, substantially square, substantially triangular, substantially rhomboid, or substantially polygonal. The edges of light holes can be substantially regular such as wave, zigzag, other regular edges, and combinations thereof. At least one of the edge of light holes or the shaped of the light holes can be substantially irregular in other embodiments.

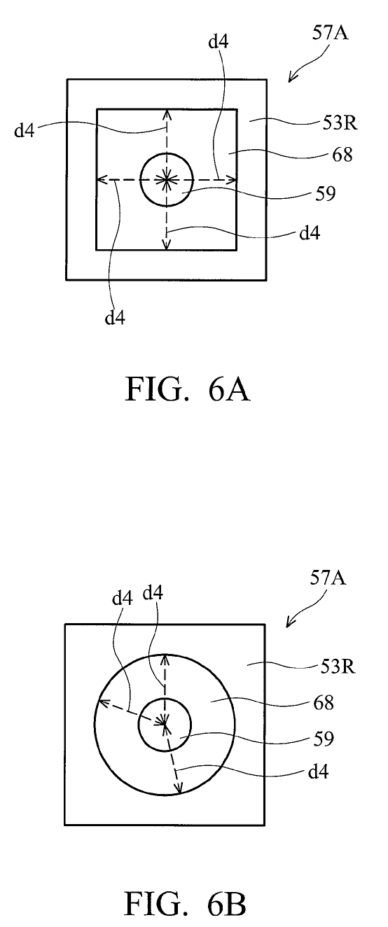

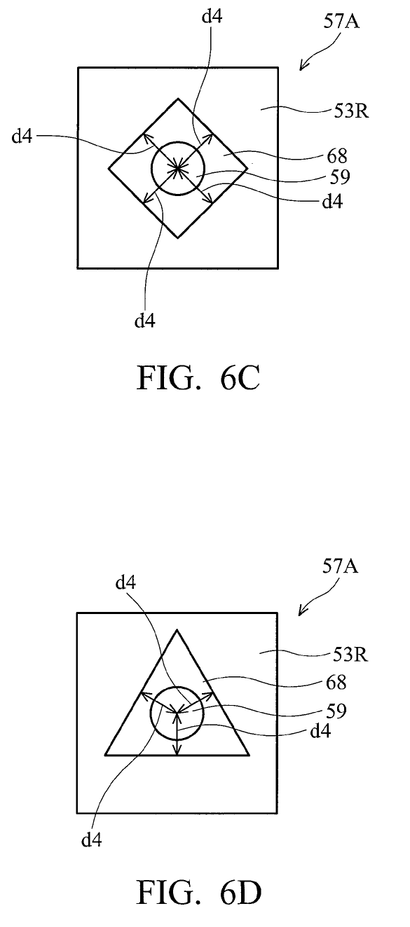

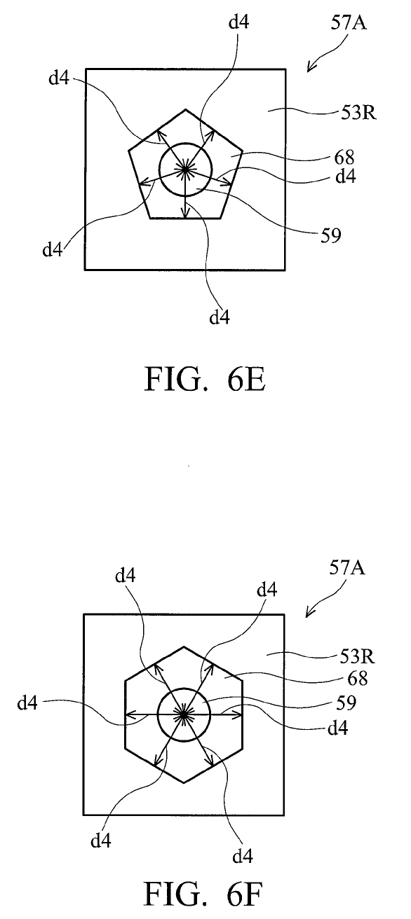

In further embodiment of the present invention, a color filter in the reflection region includes a light hole 68, wherein the alignment protrusion 59 is formed in the light hole 68, and the light hole 68 is substantially symmetrical according to the alignment protrusion 59 as a center with at least three substantially identical distances. Normalized color density in different view angles (e.g. up, down, right, left, oblique, and the like) is thus achieved. Preferred, all distances of the light holes 68 are substantially identical in all directions such as up/down/right/left/oblique. In one embodiment of the present invention, the shaped of the described light holes 68 are substantially square, substantially circular, substantially rhomboid, substantially right triangular, substantially right pentagonal, or substantially right hexagonal, or other substantially right polygonal, as shown in FIGS. 6A-6F, respectively. Distance is defined here as a distance from center to edge of the light hole. In FIG. 6A, four distances from the center of the alignment protrusion 59 (or namely the center of the light hole) to four edges of the light hole 68 are d4, and the light hole is a substantially square shaped. In FIG. 6B, all distances (e.g. up/down/right/left/oblique) from the center of the alignment protrusion 59 to edges of the light hole 68 arc d4, and the shaped of the light hole is a substantially circle. In FIG. 6C, four distances from the center of the alignment protrusion 59 to four edges of the light hole 68 are d4, and the shaped of the light hole is distances rhomboid. In FIG. 6D, three distances from the center of the alignment protrusion 59 to three edges of the light hole 68 are d4, and the shaped of the light hole is a distances right triangle. In FIG. 6E, five distances from the center of the alignment protrusion 59 to five edges of the light hole 68 are d4, and the shaped of the light hole is a substantially right pentagon. In FIG. 6F, six distances from the center alignment protrusion 59 to six edges of the light hole 68 are d4, and the shaped of the light hole is a substantially right hexagon. Note that the figures of the embodiments of the present invention are illustrated by alignment protrusion 59 formed on the color filter substrate, but are not limited thereto. In other embodiments, the light holes formed on the color filters correspond to the alignment protrusions 59 formed on the array substrate. In further embodiments, the light holes formed on a substrate include array and color filters corresponding to the alignment protrusions 59 formed on another substrate without array and color filters. In other embodiments, the light holes correspond to the alignment protrusions 59 both formed on a substrate including array and color filters, and oppositely disposed substrate includes no array and no color filters.

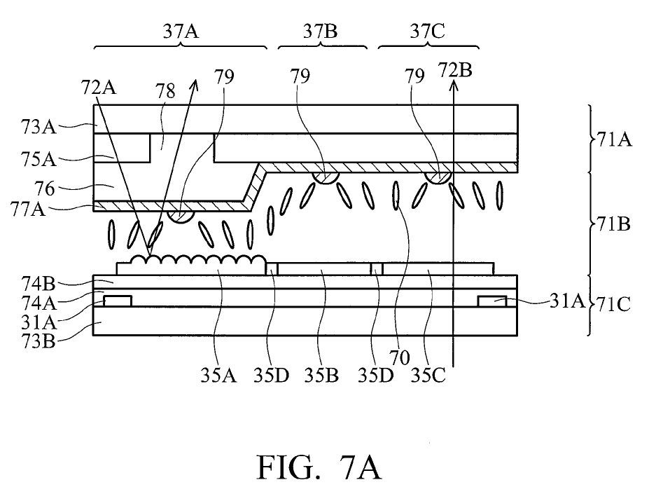

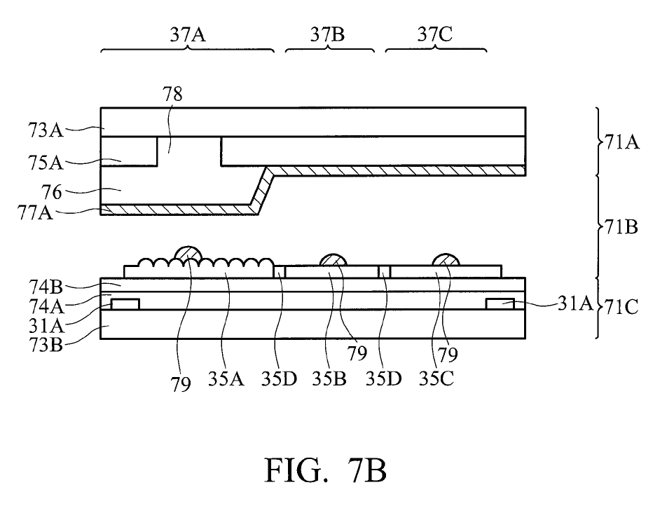

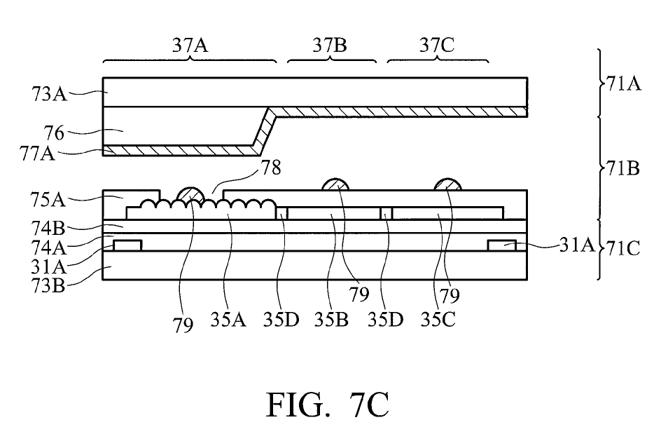

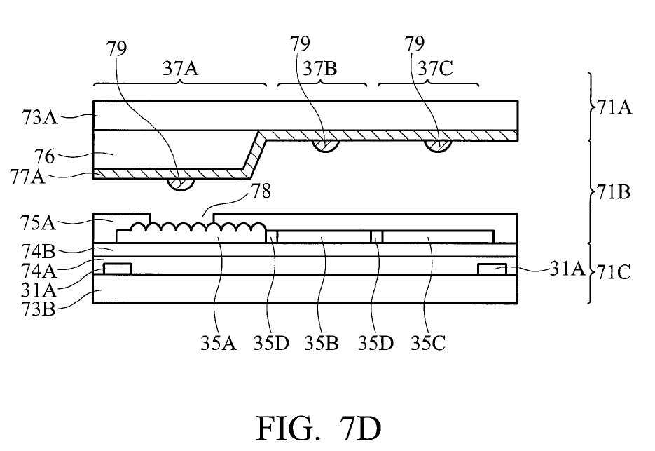

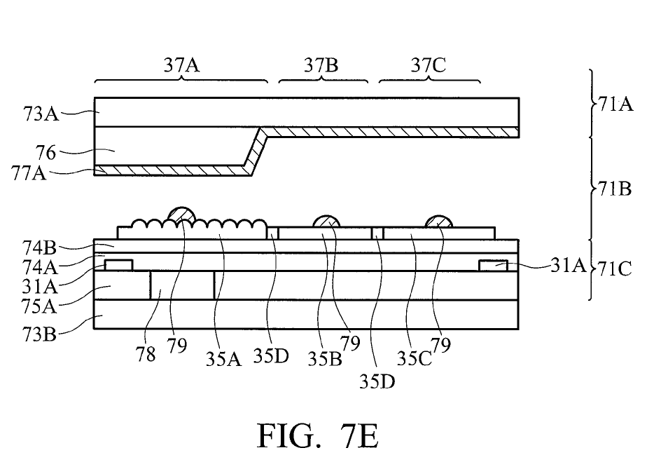

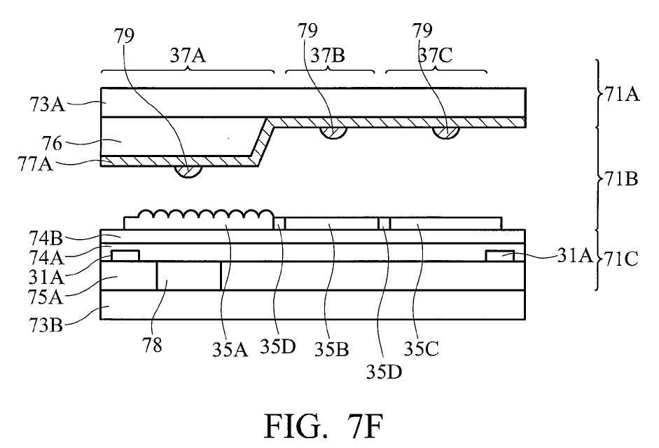

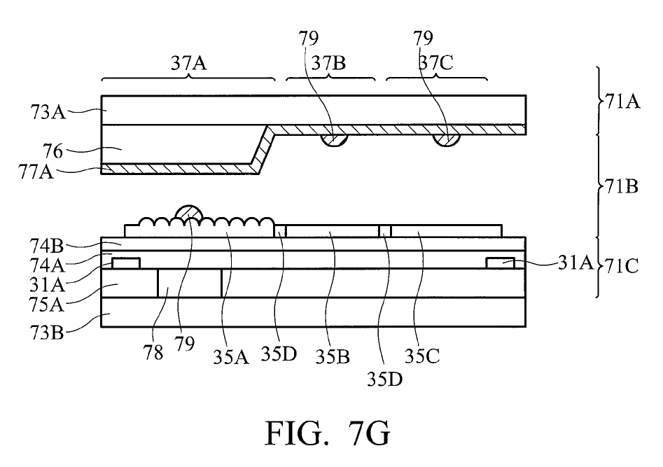

The above-mentioned of the light holes may efficiently improve the aperture ratio of the reflective LCD. FIG. 7A is a cross-section view of line A-A in FIG. 3A, wherein the liquid crystal layer 71B is disposed between the top substrate 71A and bottom substrate 71C. In FIG. 7A, top substrate is a color filter substrate sequentially comprising substrate 73A, color filter 75A with light hole 78 therein, organic material layer 76 (such as photoresist, polyester, polyimide, polyol, polyene, or others, or combinations thereof), transparent electrode layer 77A, and alignment protrusions 79 for multi-domain of the liquid crystal molecules 70. The bottom substrate 71C is a array substrate sequentially comprising substrate 73B, gate lines 31A coated by dielectric layer 74A, data lines (not shown) coated by dielectric layer 74B, and the uppermost layers such as electrode layer 35A, 35B, and 35C. For an exemplary transflective LCD, the regions 37A, 37B, and 37C are reflection region and transmission regions, respectively. The electrode layer 35A serves as reflection electrode layer in reflection region 37A, and electrode layers 35B and 35C serve as transmission electrode layers in transmission regions 37B and 37C. The electrode layers 35A, 35B, and 35C are connected by connection electrodes 35D. The reflection electrode layer includes Al, Au, Sn, Ag, Cu, Fe, Pb, Cr, W, Mo, Nd, others, nitride thereof, oxide thereof, oxynitride thereof, alloy thereof, or combinations thereof. The transparent electrode layer includes indium tin oxide (ITO), indium zinc oxide (IZO), aluminum zinc oxide (AZO), cadmium tin oxide (CTO), tin oxide (SnO₂), zinc oxide (ZnO), or other materials, or combinations thereof. The surface of the electrode layer 35A (such as reflection electrode layer) is, preferably, substantially scraggly surface, to increase the light reflection and scattering effect. The connection electrodes include reflection electrode, transparent electrode, or combinations thereof. As shown in FIG. 7A, when part of the environmental light 72A reaches reflection electrode and is reflected to be emitted, the passage only passes through color filter once. In extreme conditions, the described passage passes through no color filter. Accordingly, the conventional problem of different color densities in reflection region 37A and transmission regions 37B and 37C is solved. The ratio of environmental light 72A which only passes color filter 75A once can be tuned by area ratio of light holes 78 to the reflection region 37A. The area of the light hole 78 is preferably about ⅓ to about ⅔ of the reflection region 37A, but is not limited thereto. In FIG. 7A, the light path of the reflection region 37A and the transmission regions 37B and 37C can be similar by dual gap with an additional organic material layer 76 (such as photoresist, polyester, polyimide, polyol, polyene, or others, or combinations thereof). In dual gap design, the distance between the substrates in reflection regions can be reduced, preferably reduced to half of the distance between the substrates in transmission regions, but is not limited thereto. The present invention may adopt single gap design for simplifying process, in which the organic material layer 76 is not formed on any substrate 73A and 73B, or simultaneously formed on all surface of any substrate 73A and 73B.

The alignment protrusions are formed in a single substrate such as color filter substrate 71A in FIG. 7A, however, the present invention is not limited thereto. For example, the alignment protrusions can be formed on single substrate such as array substrate 71C as shown in FIG. 7B, on COA substrate as shown in FIG. 7C, on a substrate disposed opposite to the COA substrate as shown in FIG. 7D, on AOC substrate as shown in FIG. 7E, or on a substrate disposed opposite to the AOC substrate as shown in FIG. 7F. In another embodiment, a part of the alignment protrusions is formed on one of the substrate, and the other part of the alignment protrusions is formed on the other substrate, as shown in FIG. 7G. In FIG. 7C-7G, a dielectric layer (not shown) may be formed overlying the color filter 75A to avoid the color filter 75A being influenced by other materials. The dielectric layer includes organic materials (such as photoresist, polyester, polyimide, polyol, polyene, or others, or combinations thereof), inorganic materials (such as silicon nitride, silicon oxide, silicon oxynitride, silicon carbide, or others, or combinations thereof), or combinations thereof. Note that the organic material layer 76 is formed on substrate 73A in FIG. 7A-7G, however, the organic material layer can be formed on another substrate 73B such as on the surface of the substrate 73B, on the color filter 75A, on the electrode layer 35A, under the electrode 35A, or other position.

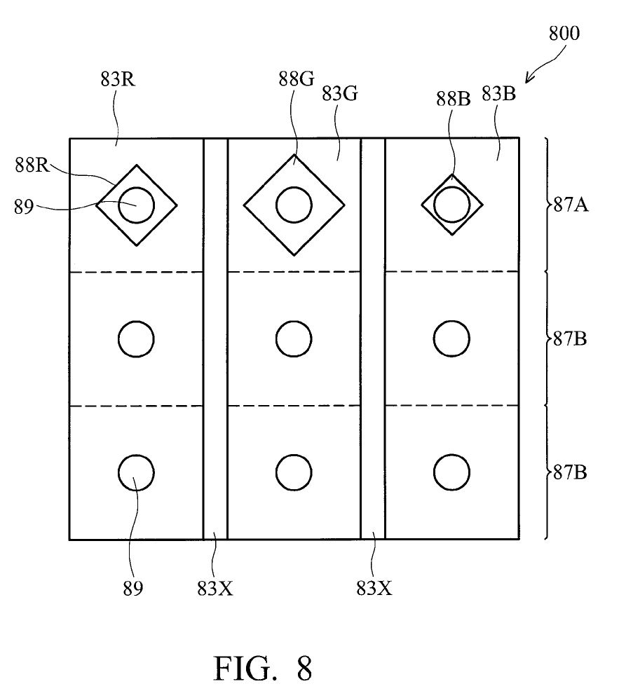

FIG. 8A is a diagram showing the color filter substrate. Color filter substrate 800 includes color filters 83R, 83G, and 83B corresponding to the sub-pixels 33R, 33G, and 33B of the array substrate, respectively. The color filters of different color are preferably separated by black matrices 83X, and each color filter independently includes reflection and transmission regions. In general, green brightness is substantially greater than red brightness, and red brightness is substantially greater than blue brightness. Therefore, the light hole 88G of the green color filter 83G is substantially larger than the light hole 88R of the red color filter 83R, and the light hole 88R of the red color filter 83R is substantially larger than the light hole 88B of the blue color filter 83B, but the present invention is not limited thereto. In an embodiment of the present invention, one light hole in one color filter is substantially greater than other light holes in other color filter, such as light holes in green color filters being substantially greater than light holes in other color (e.g. red and blue) filters. Although the shaped of the light holes 88R, 88G, and 88B are substantially squares which symmetrically correspond to the alignment protrusions 89 in up/down and right/left directions, but are not limited thereto. For example, the shaped of the light holes 88R, 88G, and 88B can be substantially circles with substantially identical distances, such as up, down, right, left, oblique, or any direction. Alternatively, the light holes in different color filters are optional in amount or shape in the described embodiments. Note that in this embodiment of the present invention, the color filter substrate is oppositely disposed to the array substrate (see FIG. 3), but is not limited thereto. Other structures or manufactures in other embodiments can be applied if necessary. Additionally, the areas of the transmission regions and the reflection regions are substantially identical in above-mentioned of the embodiments, but are not limited thereto. The area ratio of the transmission regions to the reflection regions can be tuned according to color sensitivity for human's eye.

The pixel structure in embodiments of the present invention is a general structure comprising a substrate having an active layer (such as signal lines) or other devices and another substrate having color filters and other films, but is not limited thereto. When the active layer (such as signal lines or other devices) is formed on a substrate with the color filters formed on the active layer and other substrate without color filter, this substrate is referred to as color filter on array (COA) substrate. When the color filters are formed on a substrate with the active layer (such as signal lines or other devices) formed on the color filters and other substrate without color filter, this substrate is an array on color filter (AOC) substrate. It is explained that the pixel arrangement is substantially chessboard type, but is not limited thereto. The pixel arrangement can be delta type or mosaic type, honeycomb type, other suitable types, or combinations thereof. Additionally, the pixel shape of the described embodiments is not limited to rectangle, and other shapes as substantially rhomb, substantially square, substantially pentagon, substantially hexagon, or others, or combinations thereof are optional. Although the color filters only include three colors such as red, green, and blue in embodiments, but are not limited thereto. The color filters can be colorless, cyan, yellow, magenta, brown, and/or other colors in the coordinates of the international commission on illumination (CIEs).

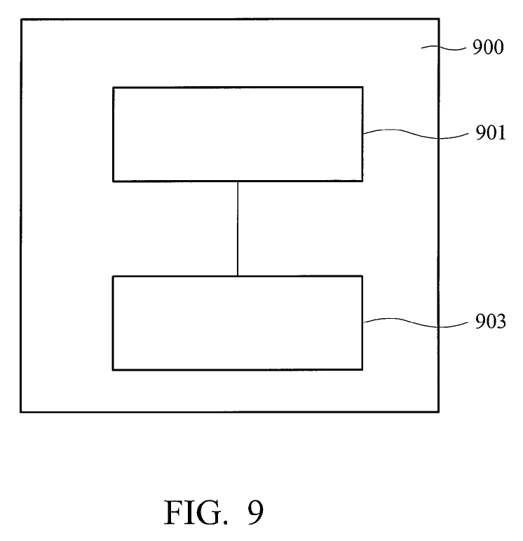

FIG. 9 is a diagram of an electronic apparatus 900 in an embodiment of the present invention. Referring to FIG. 9, the LCD panel 901 of the above-mentioned of the embodiments is applied in the electronic apparatus 900 and connected to an electric device 903 such as control device, operator device, process device, input device, memory device, driving device, illumination device, protection device, other function device, or combinations thereof. The electronic apparatus can be mobile product such as cell phone, video camera, camera, laptop computer, video game console, watch, music player, E-mail transceiver, digital photo-frame, electronic map navigation, and the like. The electronic apparatus can be visual-audio products (such as media player and the like), monitor, television, billboard (such as indoor/outdoor), projector, or others.

The color filters in reflection regions of the LCD of the present invention are patterned to form light holes. Because the light holes are substantially symmetrical distributed according to the alignment protrusion as a center, and the light holes divided by the alignment protrusion have the substantially identical area. Therefore, the color density from different view angles such as up, down, right, left, and/or oblique can be normalized. In transflective LCD, especially in reflective manipulation, the color density of different view angles such as up, down, right, left, and/or oblique can be normalized.

While the present invention has been described by way of example and in terms of preferred embodiment, it is to be understood that the present invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A liquid crystal display panel, comprising:
two oppositely disposed substrates, wherein each of the two substrates comprises a plurality of corresponding regions, at least one of the regions is a reflection region, and the reflection region comprises at least one alignment protrusion;
a liquid crystal layer formed between the two substrates;
a color filter formed on one of the two substrates, wherein the color filter in the reflection region comprises a plurality of light holes, and the light holes are substantially symmetrical distributed according to the alignment protrusion as a center.

2. The liquid crystal display panel of claim 1, wherein one of the two substrates comprises an active layer.

3. The liquid crystal display panel of claim 1, wherein the regions comprise at least one transmission region.

4. The liquid crystal display panel of claim 3, wherein the transmission region comprises the alignment protrusions.

5. The liquid crystal display panel of claim 3, wherein at least three of the regions are as a group, and the area of the transmission region of each of the regions in the group is substantially different.

6. The liquid crystal display panel of claim 3, wherein the reflection regions and the transmission regions are substantial alternately arranged.

7. The liquid crystal display panel of claim 1, wherein the color filter in the reflection regions comprises a plurality of non-light hole regions, and the alignment protrusions are formed at the boundary between the light holes and the non-light hole regions of the color filter.

8. The liquid crystal display panel of claim 1, wherein the light holes substantially symmetrical divided by the alignment protrusion have the substantially identical shape.

9. The liquid crystal display panel of claim 1, wherein the light holes substantially symmetrical divided by the alignment protrusion has substantially identical sum of area and substantially different shapes.

10. The liquid crystal display panel of claim 1, wherein the light holes substantially symmetrical divided by the alignment protrusion have the substantially identical amounts.

11. The liquid crystal display panel of claim 1, wherein the light holes substantially symmetrical divided by the alignment protrusion have substantially identical sum of area and substantially different amounts.

12. The liquid crystal display panel of claim 1, wherein the shaped of the light holes comprises substantially circular, substantially elliptical, substantially square, substantially triangular, substantially rhomboid, or substantially polygonal.

13. The liquid crystal display panel of claim 1, wherein at least three of the regions are as a group, and the sum of the area of the light holes of each of the regions in the group is substantially different.

14. The liquid crystal display panel of claim 1, wherein the light holes in the reflection regions have an area of about ⅓ to about ⅔ of the reflection regions area.

15. The liquid crystal display panel of claim 1, further comprise at least one of slits and another alignment protrusions formed in one of the two substrate, wherein the alignment protrusions are formed in reflection regions of the other of the two substrates.

16. The liquid crystal display panel of claim 1, wherein the light holes substantially symmetrical distributed in periphery of the alignment protrusions have substantially identical sum of the area.

17. The liquid crystal display panel of claim 1, wherein the light holes substantially symmetrical distributed on two sides of the alignment protrusion have substantially identical sum of the area.

18. An electronic apparatus, incorporating a liquid crystal display panel of claim 1.

19. A liquid crystal display panel, comprising:
two oppositely disposed substrates, wherein each of the two substrates comprises a plurality of corresponding regions, at least one of the regions is a reflection region, and the reflection region comprises at least one alignment protrusion;
a liquid crystal layer formed between the two substrates;
a color filter formed on one of the two substrates, wherein the color filter in the reflection region comprises at least one light hole, wherein the alignment protrusion is formed in the light hole, and the light hole is substantially symmetrical according to the alignment protrusion as a center and comprises at least three substantially identical distances from the center of the alignment protrusion to an edge of the light hole.

20. The liquid crystal display panel of claim 19, wherein the regions comprise at least one transmission region.

21. The liquid crystal display panel of claim 20, wherein the transmission region comprises the alignment protrusions.

22. The liquid crystal display panel of claim 20, wherein at least three of the regions are as a group, and area of the transmission region of each of the regions in the group is substantially different.

23. The liquid crystal display panel of claim 20, wherein the reflection regions and the transmission regions are substantial alternately arranged.

24. The liquid crystal display panel of claim 19, wherein the shaped of the light holes comprise substantially circular, substantially elliptical, substantially square, substantially triangular, substantially rhomboid, or substantially polygonal.

25. The liquid crystal display panel of claim 19, wherein at least three of the regions are as a group, and the sum of the area of the light holes of each of the regions in the group is substantially different.

26. The liquid crystal display panel of claim 19, wherein the light holes in the reflection regions have an area of about ⅓ to about ⅔ of the reflection regions area.

27. The liquid crystal display panel of claim 19, further comprise at least one of slits and another alignment protrusions in one of the two substrate, wherein the alignment protrusions are formed in reflection regions of the other of the two substrates.

28. An electronic apparatus, incorporating a liquid crystal display panel of claim 19.
